(19) United States
(12) Patent Application Publication
(10) Pub. No.: US 2026/0220665 A1
(43) Pub. Date: Jul. 30, 2026

(54) SYSTEM & ARCHITECTURE FOR DISTRIBUTION AND MANAGEMENT OF PROMOTIONAL GIFTS FOR MARKETING AND CLIENT RELATIONS

(71) Applicant: STERLING CARD SOLUTIONS HOLDINGS, LLC, Nolensville, TN (US)

(72) Inventors: Tim Leeds, Nolensville, TN (US); Austin Reichardt, Elk Grove Village, IL (US); John Elliott Cunningham, Brentwood, TN (US)

(21) Appl. No.: 19/572,204

(22) Filed: Mar. 19, 2026

Related U.S. Application Data
(63) Continuation-in-part of application No. 18/405,222, filed on Jan. 5, 2024.
(60) Provisional application No. 63/437,820, filed on Jan. 9, 2023.

(51) Int. Cl. G06Q 30/0251; G06F 21/60

(52) U.S. Cl. CPC G06Q 30/0257; G06F 21/602

(57) ABSTRACT

In one or more arrangements, a system is provided for distribution of promotional retail gift cards. In one or more arrangements, the system is configured to provide a customer user interface for a customer to purchase and manage of a plurality of marketing cards. In one or more arrangements, the marketing cards include branding and contact information of the customer for marketing. In one or more arrangements, the system is also configured to provide a recipient user interface for a recipient of one or the plurality of marketing cards from customer to select a desired retail gift card for redemption using the marketing card. In one or more arrangements, the system is configured to manage an escrow account for the customer and charge the escrow account of the customer when the marketing card is redeemed for the selected retail gift card.

### RELATED PATENT APPLICATIONS

This application is a continuation-in-part of U.S. patent application Ser. No. 18/405,222 (published as U.S. Pub. No. 2024/0232996), titled “SYSTEM & ARCHITECTURE FOR DISTRIBUTION AND MANAGEMENT OF PROMOTIONAL GIFTS FOR MARKETING AND CLIENT RELATIONS”, and filed Jan. 5, 2024, which claims priority to U.S. Provisional Patent Application No. 63/437,820, titled “SYSTEM & ARCHITECTURE FOR DISTRIBUTION AND MANAGEMENT OF PROMOTIONAL GIFTS FOR MARKETING AND CLIENT RELATIONS”, and filed Jan. 9, 2023, each of which is hereby fully incorporated by reference herein.

### FIELD OF THE DISCLOSURE

This disclosure generally relates to systems for management of marketing and client relations. More specifically and without limitation, this disclosure relates to systems for distribution and management of promotional gifts for marketing and client relations.

### OVERVIEW OF THE DISCLOSURE

In numerous industries, marketing materials such as business cards, flyers, newsletters, advertisements, etc. are distributed to advertise availability of services and provide contact information for inquiries of potential customers. For many industries, promotional gifts may be given to existing and/or potential clients to attract extra attention and develop good will with existing and/or potential clients. Such promotional gifts (also known as swag) typically include small gifts branded with the company name such as shirts, coffee cups, pens, flash drives, etc. Branding on such promotional gifts serve as a reminder of the gift to the recipient and aids to further advertise. However, such physical promotional gifts are burdensome for representatives to physically transport and maintain on their persons and/or to have available when needed. Additionally, many times physical and/or bulky gifts and/or swag are either not used or are not taken by the intended recipient, or worse, the gifts and/or swag are often summarily discarded by the recipient shortly after giving of the gift, which completely undermines the purpose of the marketing gifts and/or swag.

On the other hand, gift cards for third party retailers are easy to transport, may be used as promotional gifts, and provide some additional flexibility for recipient interests, but may not continue to serve as a reminder of the source once gifted. For example, a business card handed out with a third party retailer gift card may be discarded by the recipient, who may then forget who gave them the gift card before it is used. Essentially, there is no tie between the gifts and the marketer. In such scenario, the benefit of the promotional gift cards is reduced.

Furthermore, retailer gift cards must be purchased up front by companies who wish to distribute them for promotional marketing. However, the overhead expense for purchase of gift cards may be wasted if cards are lost or discarded by recipients (e.g., who are not interested in the retailer of the gift card). Federal law requires that gift card funds must remain valid for a minimum of five years from issuance or from the most recent fund load. Various state laws require gift card funds to remain valid for longer periods or even indefinitely. Accordingly, companies using retail gift cards for promotional gift must unnecessarily commit funds for lengthy period of time instances where cards are lost or discarded by recipients.

Furthermore, for many businesses, it also may be difficult to select retailers for gift card that have universal appeal to all potential/current clients of the business. This can lead to more instances where cards are not used by recipient, thereby exacerbating the problem of wasted expenses for purchase of lost/unused/discarded gift cards.

Accordingly, there is a long-felt but unsolved need for an improved system and method for distribution and management of promotional gifts for marketing and client relations.

Thus, it is a primary object of the disclosure to provide a system and method for distribution and management of promotional gifts for marketing and client relations that improves upon the state of the art.

Another object of the disclosure is to provide a system and method distribution for distribution and management of promotional gift cards for marketing and client relations.

Yet another object of the disclosure is to provide a system and method for distribution and management of promotional gift cards that permits recipients to select a desired retailer for the gift card.

Another object of the disclosure is to provide a system and method for distribution and management of promotional gift cards that is branded as the marketer's company.

Yet another object of the disclosure is to provide a system and method for distribution and management of promotional gift cards that include the marketer's contact information.

Another object of the disclosure is to provide a system and method for distribution and management of promotional gift cards that does not require the marketer purchase gift cards in advance.

Yet another object of the disclosure is to provide a system and method for distribution and management of promotional gift cards that can be distributed in person or though e-marketing campaigns.

Another object of the disclosure is to provide a system and method for distribution and management of promotional gift cards that collects contact information of recipient for additional marketing.

Yet another object of the disclosure is to provide a system and method for distribution and management of promotional gift cards that collects contact information of recipients' use of received gift cards.

Another object of the disclosure is to provide a system and management of promotional gift cards that is easy to use.

Another object of the disclosure is to provide a system and method distribution and management of promotional gift cards that is efficient to use.

Yet another object of the disclosure is to provide a system and method distribution and management of promotional gift cards that can be used with a wide variety of industries and marketing campaigns.

These and countless other objects, features, or advantages of the present disclosure will become apparent from the specification, figures, and claims.

### SUMMARY

In one or more arrangements, a system is provided for distribution of promotional retail gift cards. In one or more arrangements, the system includes a front end system and a back end system. The back end system is communicatively connected with the front end system. In one or more arrangements, the front end system is configured to provide a customer user interface for a customer to access the back end system to facilitate the purchase and management of a plurality of marketing cards by the customer. In one or more arrangements, the marketing cards include branding and contact information of the customer for marketing. In one or more arrangements, the front end system is also configured to provide a recipient user interface for a recipient of one or the plurality of marketing cards from customer to access the back end system to facilitate the selection of a retail gift card by the recipient and redemption of marketing card for the selected retail gift card. In one or more arrangements, the back end system is configured to manage an escrow account for the customer and charge the escrow account of the customer when the marketing card is activated for the selected retail gift card.

### BRIEF DESCRIPTION OF THE DRAWINGS

FIG. 1 shows a diagram of an example system for distribution and management of promotional gift cards, in accordance with one or more arrangements.

FIG. 2A shows an example design for a front of a marketing card design that may be created by a customer for distribution of promotional gift cards to client, in accordance with one or more arrangements.

FIG. 2B shows an example design for a back of a marketing card design that may be created by a customer for distribution of promotional gift cards to client, in accordance with one or more arrangements.

FIG. 3 shows an example process that may be performed by a marketing card management system to facilitate redemption of a marketing card, in accordance with one or more arrangements.

FIG. 4 shows an example process for marketing that may be performed by a marketing system, in accordance with one or more arrangements.

FIG. 5 shows a screenshot of an example customer user interface, in accordance with one or more arrangements; the screenshot showing the customer user interface configured to guide a new user through account setup, purchase of marketing cards, and the design and configuration of the marketing cards, in accordance with one or more arrangements.

FIG. 6 shows a screenshot of an example customer user interface, in accordance with one or more arrangements; the screenshot showing the customer user interface configured for review and management of payments and deposits for a customer account, in accordance with one or more arrangements.

FIG. 7 shows a screenshot of an example recipient user interface, in accordance with one or more arrangements; the screenshot showing an example customer-branded landing page, where customer is directed to register and redeem the marketing card.

FIG. 8 shows a screenshot of an example recipient user interface, in accordance with one or more arrangements; the screenshot showing an example marketplace provided by recipient user interface for redemption of a marketing card for a selected retailer cards.

FIG. 9 shows a screenshot of an example recipient user interface, in accordance with one or more arrangements; the screenshot showing an interface screen for the example marketplace that is displayed when a retail gift card is selected by the recipient; the screenshot providing an option for the recipient to use a credit provided by the marketing card to redeem the selected retail gift card.

FIG. 10 shows a screenshot of an example recipient user interface, in accordance with one or more arrangements; the screenshot showing an interface screen for the example marketplace that is displayed for a recipient to confirm the transaction for redemption of the selected retail gift card by the recipient.

FIG. 11 shows a flowchart of an example process for distribution and management of marketing cards, in accordance with one or more arrangements.

FIG. 12 shows an example data processing system that may be used to implement systems, circuits, components, and/or processes of back end and/or front end systems, in accordance with one or more arrangements.

FIG. 13 shows a flowchart of an example process for distribution and management of marketing cards, in accordance with one or more arrangements.

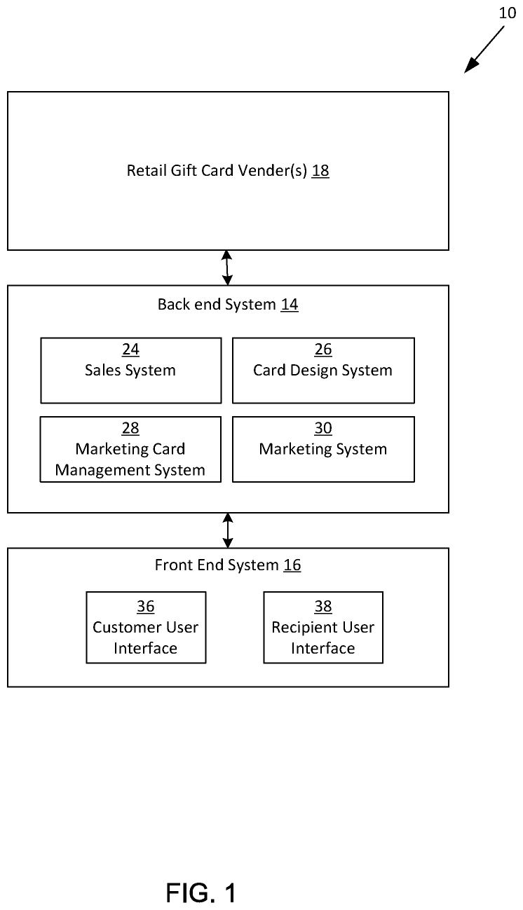

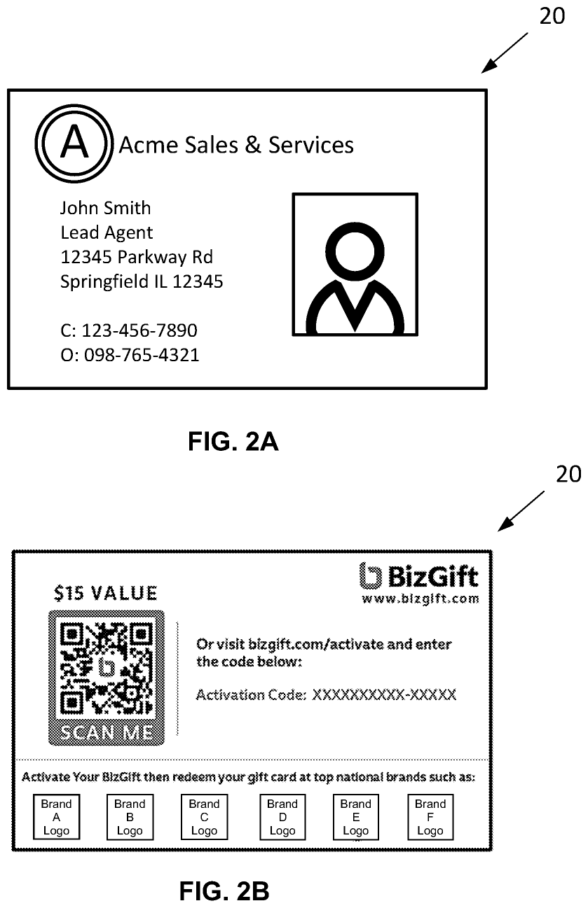

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments that provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of gift cards. However, the embodiments are not so limited. It is appreciated that the embodiments may be adapted for use in other applications which may be improved by the disclosed structures, arrangements and/or methods. The system is merely shown and described as being used in the context of context of gift cards for ease of description and as one of countless examples.

### System 10

With reference to the figures, a system and method for distribution and management of promotional gift cards is presented (system 10). For ease of reference, promotional gift cards may be referred to as marketing cards and such terms are used interchangeably herein. In one or more arrangements, system 10 includes a front end system 16 and a back end system 14, which is communicatively connected to the front end system 16 and to one or more retail gift card venders 18, among other components.

### Back End System 14

Back end system 14 is formed of any suitable size, shape, design, and/or technology and is configured to perform one or more functions for distribution and management of marketing cards 20 and redemption of such marketing cards 20 by recipients for retail gift cards 22. In the arrangement shown, as one example, back end system 14 includes a sales system 24, a design system, 26, a marketing card management system 28, and a marketing system 30, among other components.

### Sales System 24

Sales system 24 is formed of any suitable size, shape, design, and/or technology and is configured to facilitate selection and purchase of marking card 20 packages by customers. In the arrangement shown, as one example, in response to user input from front end system 16, sales system 24 facilitates user selection of the type (e.g., physical and/or e-card) and number of marketing cards 20 as well as the monetary value of the cards. While the arrangements may be primarily discussed with reference to examples of marketing card 20 packages with all marketing cards 20 having the same value, the arrangements are not so limited. Rather, it is contemplated that in one or more arrangements, sales system 24 may be configured to facilitate purchase of marketing cards 20 of any number of different values.

In one or more arrangements, after the marketing card 20 package is selected and configured and customer submits the order, sales system 24 initiates payment transaction and/or transfer of funds for the cost of marketing cards 20 and the selected value. In one or more arrangements, system 10 does not require payment for the full value of all marketing cards when purchase is made. Rather, in one or more arrangements, system 10 is configured to maintain a customer escrow account for a certain portion of the purchased marketing cards 20. As marketing cards 20 are activated by recipients for retail gift cards 22, amounts required for purchase of the retail gift cards 22 are deducted from the customer escrow account. In one or more arrangements, when escrow amount drops below a certain threshold, customer is notified to deposit additional funds. In some arrangement, system 10 may be configured to automatically transfer money from a designated customer account and/or charge a designated customer credit card to replenish amounts in the escrow account once it has dropped below a designated threshold.

However, the arrangements are not so limited. Rather, it is contemplated that in addition to or in lieu of the escrow account, in one or more arrangements system 10 may be configured to transfer money from a designated customer account and/or charge a designated customer credit card at the time marketing cards 20 are activated to be redeemed for one or more retail gift cards 22. Additionally or alternatively, in one or more arrangement, system 10 may track marketing cards 20 that are redeemed for retail gift cards 22 and invoice the customer at a later time (e.g., monthly). Because the customer is not charged for the value of marketing cards 20 until they are activated for retail gift cards 22, customer will not waste money for marketing cards 20 that are lost, discarded, or never used by recipients. Furthermore, the upfront costs for a marketing campaign can be spread out over time and therefor easier to budget marketing campaigns.

### Design System 26

Design system 26 is formed of any suitable size, shape, design, and/or technology and is configured to perform various functions to facilitate design and/or customization of marketing cards 20 by the customer. For example, using customer user interface of front end system 16, in one or more arrangements, design system 26 permits a customer to configure the printed content/information, graphics, layout, shape, material, and/or any other design element of marketing cards 20. After configuration and review, the user may then prompt design system 26 to submit an order for manufacture of the designed marketing cards 20.

### Marketing Card Management System 28

Marketing card management system 28 is formed of any suitable size, shape, design, and/or technology and is configured to perform various functions to track status and/or balances of purchased cards and/or customer accounts. In one or more arrangements, marketing card management system 28 is configured to track status and various information throughout the life cycle of marketing cards 20. In one or more arrangements, marketing card statuses may include but are not limited to, for example, unused, sent (e.g., for an emailed e-card), registered, activated, or any other status. In one or more arrangements, marketing card management system 28 is configured to track date and/or time of each status change, information given by recipient when registering (e.g., name, email, phone, address, and/or any other information that may be collected), marketing card 20 balance, redemption information (e.g., what retail gift card(s) 22 was redeemed, recipient browning history for retail gift cards 22, and/or any other information that may be collected in the redemption of a marketing card 20).

In one or more arrangements, marketing card management system 28 is additionally or alternatively configured to manage transactions for redemption of marketing card 20. For example, in one or more arrangements, when a card is redeemed, marketing card management system 28 may charge the customer account associated marketing card 20 and communicate with a gift card retailer to facilitate purchase and delivery of the desired retail gift card 22 to the recipient (e.g., by mail and/or email).

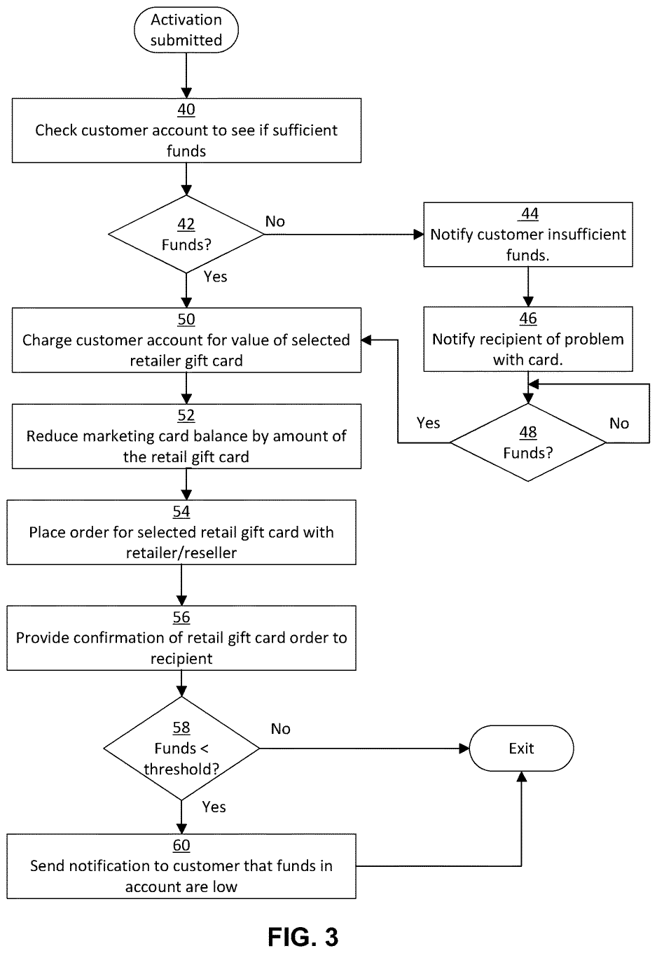

FIG. 3 shows an example process that may be performed by marketing card management system 28 to facilitate activation and redemption of a marketing card 20 in accordance with one or more arrangements. In this example arrangement, the process is initiated in response to a recipient submitting a redemption request (e.g. via front end system 16). In this example, at process block 40, marketing card management system 28 checks a customer account associated with the marketing card 20 to be activated by the recipient to see if there are sufficient funds (e.g., in a deposit escrow account). In this example, if there are not sufficient funds to cover the value of the marketing card 20 to be activated at decision block 42, the customer is notified at process block 44 that there are insufficient funds for the transaction and request that the customer deposit additional funds. In this example, at process block 46 the recipient is notified with a message that requested transaction cannot be completed (e.g., “There is a problem with the card and the requested transaction could not be completed. A report has been submitted. You will be notified with the transaction can be completed. Thank you for your patience”). In this illustrative example, the process hangs at decision block 48 until customer deposits sufficient funds to cover the transaction. After which the process, proceeds to process block 50.

However, the arrangements are not so limited. Rather, as previously described it is contemplated that in some arrangements marketing card management system 28 may alternatively transfer money from an external account and/or charge a designated credit card if there are not sufficient funds in customer's account. Additionally or alternatively, in one or more arrangements, marketing card management system 28 and invoice the customer at a later time for the redeemed value.

In this example, once there are sufficient funds, the process continues to process block 50, where the customer account is charged for the activated value of the selected retailer gift card 22. At process block 52, the balance for the marketing card is reduced by the redeemed value. At process block 54, an order is placed for the selected retail gift card 22 with the applicable retailer, issuer, or reseller of gift cards.

In this example arrangement, the retailer, issuer, or reseller sends the purchased retail gift card 22 directly to the recipient outside of this flow (e.g., via mail or email). However, the arrangements are not so limited. Rather, it is contemplated that in some arrangements, the purchased retail gift card 22 may be initially provided to the system 10 and then forwarded to the recipient.

In this example, a confirmation of the redemption is provided to the recipient at process block 56. In this example, after providing the confirmation to the recipient, if available funds have dropped below a threshold amount at decision block 58, the process sends a notification to the customer at process block 60 to alert the customer that additional funds may need to be deposited.

### Marketing System 30

In one or more arrangements, when recipients register a marketing card 20, system 10 is configured to obtain contact information for the recipient along with consents to be contacted for marketing by the customer who purchased the marketing card. In one or more arrangements, back end system 14 optionally includes a marketing system 30 to facilitate such marketing. Marketing system 30 is formed of any suitable size, shape, design, and/or technology and is configured to facilitate customer-branded marketing to recipient during the redemption process. In various different arrangement, marketing system 30 may be configured to send marketing materials (e.g., emails, txt messages, phone calls, newsletters, mailing, and/or other marketing materials) at various times in the redemption process. Additionally or alternatively, in one or more arrangements, marketing system 30 is configured to continue marketing to recipient on behalf of the customer following redemption of the marketing card 20 for a retail gift card 22.

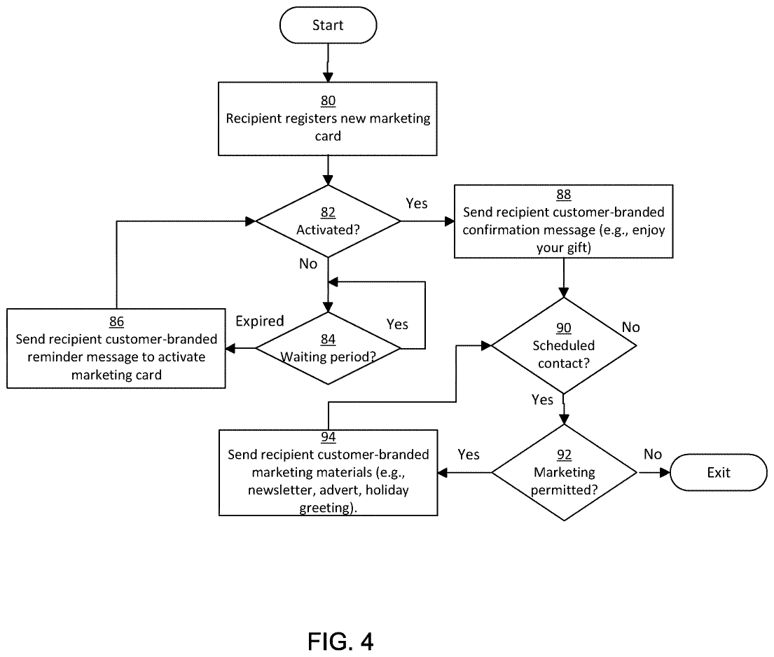

FIG. 4 shows an example process for marketing that may be performed by marketing system 30 in accordance with one or more arrangements. In this example arrangement, the marketing process begins with recipient registering a new marketing card 20 at process block 80. As previously described in the registration process, contact information of recipient and necessary consents are obtained to permit marketing to recipient on behalf of the customer who purchased the marketing card 20. After registration, if the marketing card 20 is not activated at decision block 82, the process waits at decision block 84 for a predetermined waiting period. Once the waiting period expires, the process proceeds to process block 86, where the recipient is sent a customer-branded reminder to redeem the marketing card 20. In some arrangements, the reminder message may include content to market other products and/or services of the customer. The process loops in this manner until the marketing card 20 is activated.

Once the marketing card 20 is activated, the process proceeds from decision block 82 to process block 88, where a customer-branded message confirming redemption of the marketing card 20 for a retail gift card 22 is send to the recipient. In some arrangements, the confirmation message may include content to market other products and/or services of the customer.

In this example arrangement, marketing system 30 continues to send customer-branded marketing materials to recipient after redemption according to a marketing schedule while marketing to recipient is permitted (e.g., while recipient has not requested to not be contacted for marketing purposes). In this example, when contact of the recipient is scheduled, the process proceeds from decision block 90 to decision block 92. If marketing to the recipient is still permitted at decision block 92, the process proceeds to process block 94, where customer-branded marketing content (e.g., emails, txt messages, phone calls, newsletters, mailing, and/or other marketing materials) is sent to the recipient. The process then returns to decision block 90. The process loops in this manner and sends marketing materials to recipient when scheduled until marketing is no longer permitted at decision block 92.

It is recognized that various consumer protection laws may limit the length of time that recipient may be contacted for marketing following registration of the marketing card and/or limit the manner in which marketing can be performed. For example, marketing may be limited by national and/or state do not call lists and/or stop and/or unsubscribe requests received from recipients. In one or more arrangements, marketing system is configured to maintain do not contact lists for each form of marketing (e.g., landline phone, cellular phone, text messaging, email, etc.), cross reference with do not call databases, and track permitted durations that customers may be contacted to track which methods may be used to market to each recipient at any given time. In one or more arrangements, when marketing system 30 is scheduled to contact a recipient for marketing, marketing system 30 determines which methods may be used to contact the recipient for marketing purposes (if any) and automatically selects one of those methods to contact the recipient.

### Communication With Gift Card Vendors 18

In some arrangements, back end system 14 is configured to communicate with one or more retail gift card venders 18 to determine available retail gift cards 22, available card forms (e.g., physical cards and/or e-cards) pricing, discounts and special offers, commissions and/or referral fees, and/or any other information that may be relevant to the purchase of retail gift cards 22 and/or to facilitate purchase of retail gift cards 22 selected by recipients for redemption. In one or more arrangements, back end system 14 may be configured with application program interfaces (APIs) that are adapted to communicate with the respective gift card vender 18 systems. However, the arrangements are not so limited. Rather, it is contemplated that in some various arrangements, back end system 14 is configured to retrieve retail card information and submit orders using various means and methods including but not limited to, for example, supplier provided APIs, custom APIs, SQL queries, file downloads (e.g., catalogs, data sheets, etc.), scraping of websites, automated submission of orders (e.g., via email, fax, FTP, Dropbox, and/or any other means or methods for submission of orders)

### Front End System 16

In one or more arrangements, system 10 includes a front end system 16. Front end system 16 is formed of any suitable size, shape, design, and/or technology and is configured to provide one or more user interfaces for end users to communicate and interact with back end system 14 to facilitate input, access to, and processing of data stored therein and/or perform various operations related to marketing cards 20 and/or retail gift cards 22.

In one or more arrangements, system 10 includes multiple user interfaces for use by the different types of end-users. In some various different arrangements shown, front end systems 16 includes a customer user interface 36 and a recipient user interface 38. However, the arrangements are not so limited to the user interfaces described herein. Rather, it is contemplated that in some various arrangements, system 10 may include any number of user interfaces configured for access by various categories of end users.

### User Interfaces

Customer user interface 36 provided by front end system 16 may be formed of any suitable size, shape, and design, and/or technology and is configured to permit customer end users to interact with back end system 14 to facilitate input, access to, and processing of relevant data to facilitate purchase, design, configuration, and/or management of marketing cards.

In one or more arrangements, customer user interface 36 may additionally or alternatively permit user to perform various action related to marketing cards including but not limited to, for example, management of account, reviewing escrow balance, review purchase and use history, submit payments and/or transfer funds, design and manage marketing performed by system 10 for customer, track and review information collected on recipients, cross referenced with customers client list to assess rate of return of marketing campaigns, and/or any other useful action.

Additionally or alternatively, in one or more arrangements, customer user interface 36 may permit customer to interact with back end system 14 to perform data analytics on information on customer's recipients to derive insight or additional data metrics that may be useful for future marketing efforts. As one example, it may be useful to know what retailers were selected by the recipients. As another example, it may be useful to identify and determine commonalities of recipients that developed into clients of the customer.

In one or more arrangements, customer user interface 36 may additionally or alternatively permit customer to configure and adjust options presented to recipients after registering a marketing card 20. For example, in one or more arrangements, system 10 may permit customer to customize what retailer gift cards are presented to recipient (e.g., by recipient user interface 38) for a marketing card 20 for selection. For example, in one or more arrangements, system 10 may permit customer to customize the appearance and/or content that is displayed to customers recipients by the recipient user interface 38.

In one or more arrangements, one or more of the customer user interface 36 and recipient user interface 38 may be provided by, for example, execution of a local application on a personal electronic device (e.g., a smartphone, tablet, laptop, wearable device, and/or or other computing or electronic device). Additionally or alternatively, in one or more arrangements, one or more of the customer user interface 36 and recipient user interface 38 may be provided by web-based application executed in a web browser. Such web application may be, for example, a web portal hosted by a web server on back end system 14 or by a third-party service provider. Additionally or alternatively, in one or more arrangements, one or more of the customer user interface 36 and recipient user interface 38 may be provided by a program executed on a computer or other electronic device communicatively connected to back end system 14.

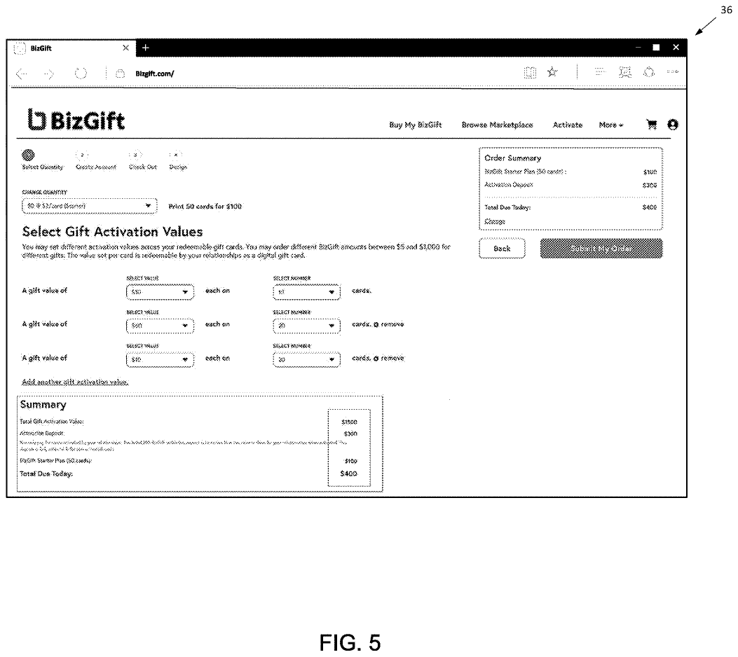

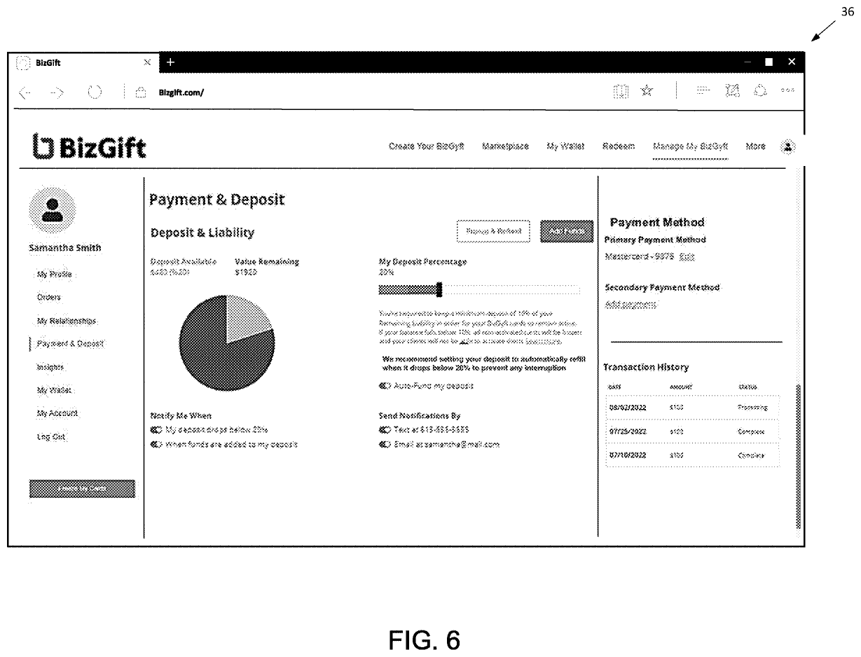

FIGS. 5-6 show screenshots of an example customer user interface 36 of front end system 16, consistent with one or more arrangements. In the example shown in FIG. 5, the customer user interface 36 is configured to guide a new user through account setup, purchase of marketing cards 20, and the design and configuration of the marketing cards 20. In the particular screenshot shown in FIG. 5, customer user interface 36 provides an interface screen to permit a user to select a marketing card 20 package for purchase and configure gift values for various numbers of the marketing cards 20 that will be purchased. In this illustrative example, the system 10 requires the customer to pay a fee for the purchased marketing cards 20 as well as a deposit fee equal to 20% of the selected total value for the marketing cards 20 to be placed in an escrow account for the customer. In this illustrative example, after the order is submitted, the customer will be prompted to login or create an account and then submit payment information to check out. In this example, after checkout, the customer is prompted to design and/or configure the marketing cards 20 and submit the design for manufacture of the marketing cards 20. However, the arrangements are not so limited to this example interface or process flow. Rather, it is contemplated that in various different arrangements, customer user interface 36 may have various different configurations and utilized various different process flows for customers to purchase and design marketing cards 20. For example in some arrangements, customer may be prompted to design marketing cards 20 prior to checkout.

FIG. 6 shows an example screenshot of the example customer user interface 36 configured for review and management of payments and deposits for a customer account. In this example arrangement, the customer user interface 36 permits the customer to view account balance as well as the remaining value of unused marketing cards 20. In this example arrangement, the customer user interface 36 permits the customer to set up various notifications for the customers account (e.g., when the amount in account drops below a threshold or when funds are added to the account). In this example arrangement, the customer user interface 36 permits the customer to transfer funds into or out of the account or to set up automatic deposits to ensure funds are available when marketing cards 20 are activated by recipients.

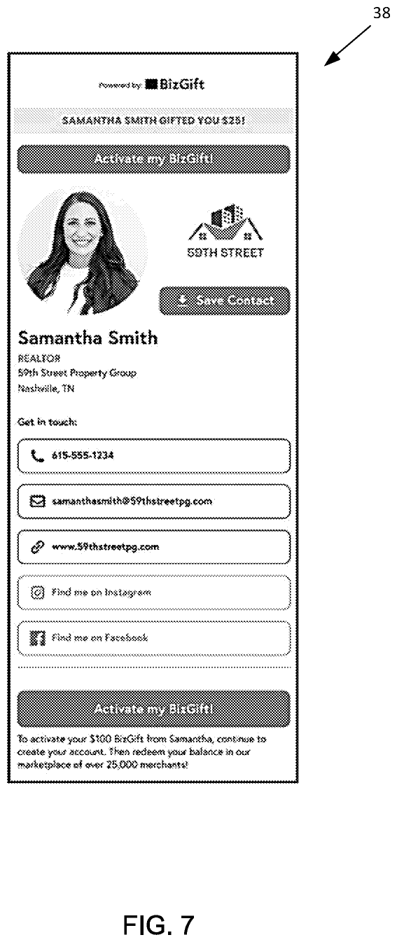

FIGS. 7-10 show screenshots of an example recipient user interface 38, consistent with one or more arrangements. FIG. 7 shows a screenshot of a customer-branded landing page of recipient user interface 38 that customer is directed to register and redeem the marketing card 20. In one or more arrangements, the recipient may be directed to the landing page, for example, by clicking a link of the marking card (for an e-card), going to a web address shown on a physical or e-based marketing card 20, and/or scanning a QR code on a physical or e-based marketing card. In one or more arrangements, the web address and/or QR code may include information for system 10 to identify the particular marketing card 20. Additionally or alternatively, the landing page may prompt the recipient to enter a unique ID/code indicated on the marketing card 20.

In this example, the landing page is branded with the logo and contact information for the customer and provides a simple interface button to save the customers contact information, call the customer, email the customer, visit the customers website, and/or link to the customer on various social media platforms. In this example, the landing page also has an interface button to activate the marking card.

Upon clicking on the button to activate the card, recipient user interface 38 prompts the recipient to register an account. In one or more arrangements, in the registration process, recipient is prompted to provide contact information of the recipient. In one or more arrangements, in the registration process, recipient is asked to consent to be contacted by customer for marketing.

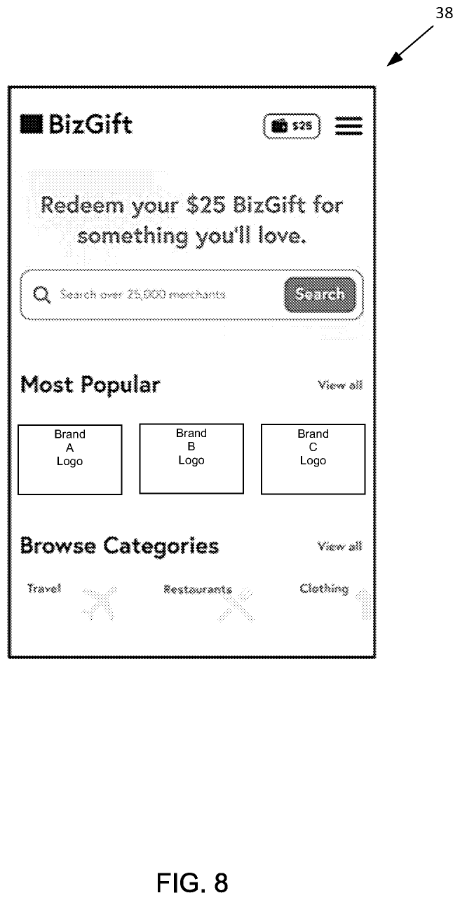

Upon registering and activating, recipient user interface 38 provides access to a marketplace for the recipient to browse various retail gift cards 22 that may be redeemed using the marketing card 20. In some various arrangements, the marketplace may be hosted by system 10 or may be hosted by a third party (e.g., by a gift card retailer). FIG. 8 shows a screenshot of an example marketplace provided by recipient user interface 38, in accordance with one or more arrangements. In this example, the marketplace permits a recipient to search for particular retailers and/or browse retails by category or popularity. However, the arrangements are not so limited. Rather, it is contemplated that in some various arrangements, the marketplace provided by recipient user interface 38 may utilize various other arrangements and/or means for browsing retailer gift cards 22.

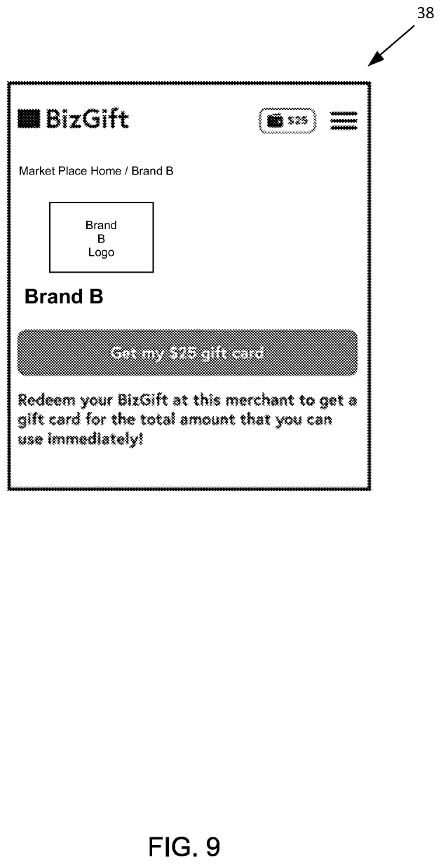

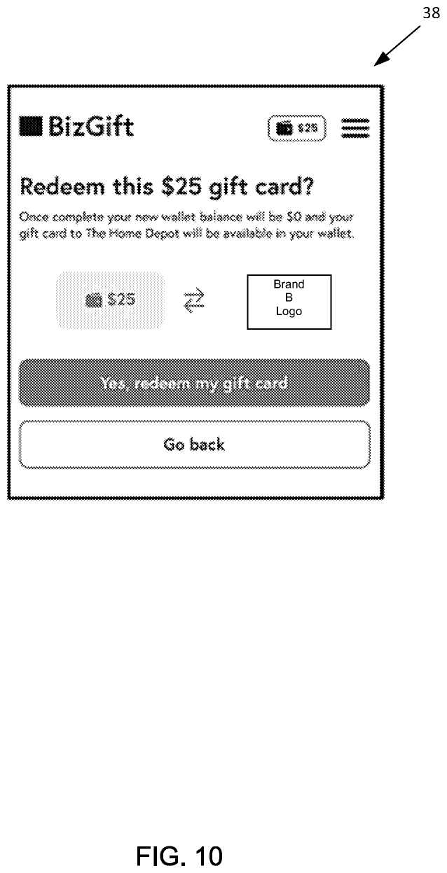

FIG. 9 shows a screenshot of an interface screen for the example marketplace that is displayed when a retail gift card 22 is selected by the recipient. In this example, the interface screen has a button for the user to redeem the marketing card 20 for the selected retail gift card 22. In this example, after the recipient selects to redeem the selected retail gift card 22, the recipient user interface 38 is configured to provide a second interface screen as shown in FIG. 10 for the recipient to confirm the selection and proceed with redemption of the selected retail gift card 22.

However, the arrangements are not limited to the customer user interface 36 and recipient user interface 38 examples and configurations shown in the figures and/or described herein. Rather, it is contemplated that in various different arrangements, customer user interface 36 and recipient user interface 38 may be implemented with various different layouts configurations, features, and/or user interactions.

### In Operation

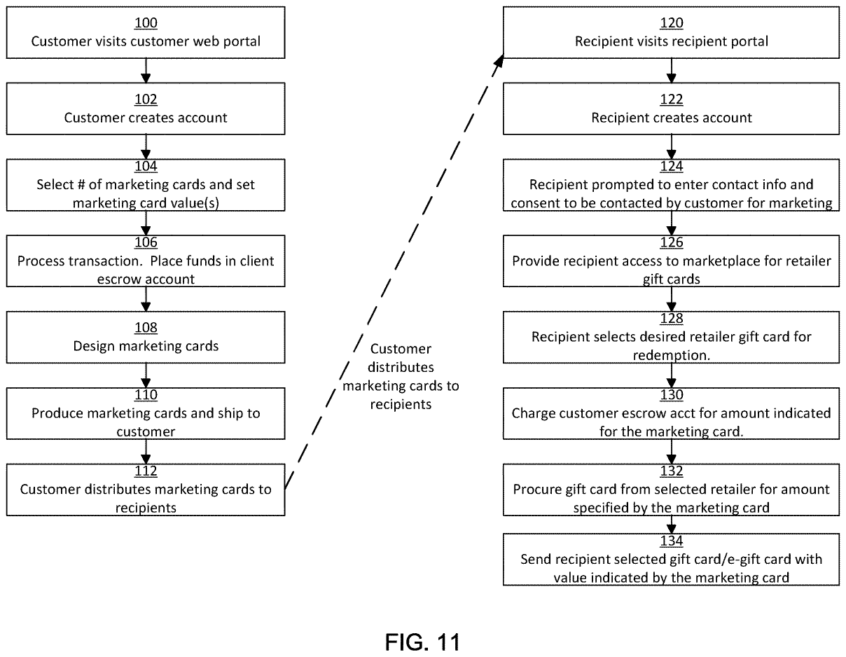

FIG. 11 shows a high level flowchart of an example process performed by the system 10 in operation, in accordance with one or more arrangements. In this illustrative example, at process block 100, a customer visits a customer web portal provided by customer user interface 36. At process block 102, the customer creates an account. At process block 104, the customer selects the number of marketing card 20 to be purchased and the monetary amounts for the marketing cards 20. At process block 106, the purchase transaction is processed and excess funds are placed in client escrow account. At process block 108, customer user the customer user interface 36 to design the appearance, layout, and/or other features marketing cards 20. In this example, at process block 110, marketing cards are produced and shipped to customer. However, if e-cards are purchased, marketing cards 20 may simply be emailed to customer. Alternatively, in some arrangements, customer user interface 36 may provide customer the ability to send e-marketing card 20 from system directly to recipients specified by customer. At process block 112, customer distributes marketing cards 20 physically or electronically to recipients.

At process block 120, a recipient of a marketing card 20 visits a recipient web portal provided by recipient user interface 38. At process block 122, recipient creates an account. At process block 124, recipient is prompted to enter contact information and consent to be contacted by customer for marketing purposes. At process block 126, recipient user interface 38 provides recipient access to a marketplace to browse available retail gift cards 22. At process block 128, recipient selects a desired retail gift card for redemption. At process block 130, customer escrow account is charged for the amount indicated for the recipients marketing card 20. At process block 132, a gift card is procured from the selected retailer for the amount specified on the marketing card 20. At process block 134, the retail gift card 22 (or e-gift card) is send to the recipient.

### Code Security and Secure Digital Delivery

In one or more arrangements, a unique ID/code is associated with each marketing card and is used by back-end system 14 to track and validate activation of marketing cards. However, security is challenging as some implementations may be susceptible to enumeration and/or replay attacks. Security is further challenging in the context of digital delivery of gift cards and marketing cards (i.e., e-cards). In one or more arrangements, system 10 is configured to permit a user to send digital marketing cards to recipients. However, the most widely used and convenient communication methods (e.g., email and SMS) communicate data unencrypted and are susceptible to various attacks if communication is observed by an attacker.

Various cryptographic encoding and decoding methods are available to assist with secure communication of data between parties. However, many of such cryptographic methods require a secure way of sharing a private key used to encrypt and decrypt the message, which is not practical for distribution of marketing cards. Public key cryptographic encoding and decoding methods are able to establish secure communication channels without the advance exchange of private keys. However, public key cryptographic methods require expensive encoding/decoding hardware and processing resources. Moreover, many consumer email and SMS applications do not provide cryptographic capabilities. Accordingly, there is a need in the art to facilitate physical and digital distribution of unique IDs/codes (or other secure information) for secure tracking and validating marketing cards during activation.

In one or more arrangements, a novel cryptographic method is presented for generation and encoding of unique IDs/codes for distribution with physical and/or digital marketing cards. In one or more arrangements, when a set of marketing cards are purchased, back end system 14 is configured to generate a set of unique IDs/codes for set of marketing cards. The set of unique identifiers are then encrypted using a plurality of different encryption scripts. In some various arrangements, the different encryption scripts may utilize different types of encryption algorithms or may use the same type of encryption algorithm with different private keys for each encryption script. In one or more arrangements, the scripts are configured so the encrypted ID/code will not include characters that are problematic in URLs, emails, or storage (e.g., \ / \hat{ } £ $ % & ( ) } { @ # ~ ? > < > , | = _ + ¬ −). In one or more arrangements, if encrypted output contains any disallowed characters, the system automatically retries the encryption again with a new encryption script. This retry loop continues until a character-safe output is produced

In one or more arrangement, when encrypting each unique ID/code, the process shuffles a list of the encryption scripts and select one of the scripts at random and uses the selected script to encrypt the unique ID/code. As used herein, unless indicated otherwise, random selection may refer to a selection that is either truly random or pseudo-random. In one or more arrangements, a script identifier of the selected script is then concatenated to the encrypted unique ID/codes for form a secure unique ID/code that may be distributed with a physical or digital marketing card. In one or more arrangement, the marketing cards include a web link, QR code, or other mechanism includes a web address for the recipient user interface for activation of the marketing card. In one or more arrangements, the secure unique ID/code is included as a slug in the web address. When a marketing card is activated by a recipient, the script identifier is used to determine which script to use to decrypt the encrypted unique ID/code for verification of the marketing card.

This approach for encryption of unique IDs/codes for marketing cards using randomized encryption scripts provides several benefits. As one example, the encrypted output generated by the process is non-deterministic. Non-deterministic encryption enhances security by producing different ciphertext for the same plaintext each time it is encrypted, preventing attackers from spotting patterns, performing frequency analysis, or identifying repeated data. This encryption approach also prevents an attacker from enumerating valid codes as encryption scripts are not exposed outside of the system. Additionally, since encryption/decryption processes are all performed the system 10, private-key encryption algorithms can be utilized, which are generally faster and require fewer computing resources (e.g., processing time, memory, energy usage, etc.) in comparison to public-key encryption that is typically used to establish secure communication channels. The character-safety validation and automatic retry ensures the encrypted secure unique IDs are safe to transmit in all channels. As an additional benefit, the selected script that is added to the encrypted unique ID/code facilitate efficient routing of secure unique IDs received from marketing card recipients to the appropriate encryption script engine for decryption without needing an external lookup table. Finally, this approach permits marketing cards to be generated, distributed, and activated without exposing unencrypted unique IDs/codes in emails, SMS messages, locks, URLs, activation link, or in any other manner.

While the disclosed method prevents unique IDs/codes from being forged by third parties, in the context of distributing digital marketing cards (i.e., ecards), it is recognized that an attacker could potentially intercept and attempt to activate the digital marketing card prior to the intended recipient. To prevent this type of attack, when a secure unique ID/code is received by back end system 14 for activation the identify or the recipient is verified in addition to authenticating the marketing card.

In one or more arrangements, when a secure unique ID/code is received by back end system 14 for activation the system is configured to perform the following steps:
Decrypt the secure unique ID/code;
Verify the decrypted unique ID/code corresponds to a valid marketing card that has not already been activated, has not expired, and/or that the associated order has not been refunded;
For digital marketing cards:
   Use the decrypted ID/code to look up the email/SMS to which the marketing card was originally sent;
   Generate and send a challenge token to the determined email/SMS;
   Prompt the user to enter the challenge token to verify identify of the recipient.

### Encryption Algorithms

In various arrangements, various different encryptions algorithms may be used for encryption/decryption of unique IDs/codes of marketing cards. In one or more preferred arrangements, system 10 is configured to encrypt unique IDs/codes using one or more private key encryption algorithms known in the art. As previously mentioned, private key encryption algorithms are generally faster and require fewer computing resources (e.g., hardware, processing time, memory, energy usage, etc.) in comparison to public-key encryption algorithms. Such private key encryption algorithms may include but are not limited to, for example, Advance Encryption Algorithm (AES), Twofish, Blowfish, Salsa20/ChaCha20, Data Encryption Standard (DES), 3DES, RC4, CAST5, Kuznyechik, and/or any other private key encryption algorithm. However, the arrangements are not so limited. Rather, it is contemplated that in some arrangements, system may be adapted to additionally or alternatively encrypt unique IDs/codes using one or more public key encryption algorithms (e.g., RSA, Diffie-Hellman, Rabin, ElGamel, Elliptic curve cryptography (ECC), and/or any other public key encryption algorithm).

### Data Processing System 200

Various blocks, modules, or other circuits of the back end system 14 and front end system 16 may be implemented to carry out one or more of the operations and activities
described herein and/or shown in the figures. In these contexts, a “block” (also sometimes “logic circuit,” “control circuit,” “processing circuit,” “server,” “module,” “data processing system” or “system”) is a circuit specifically configured and arranged to carry out one or more of these or related operations/activities. For example, such circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

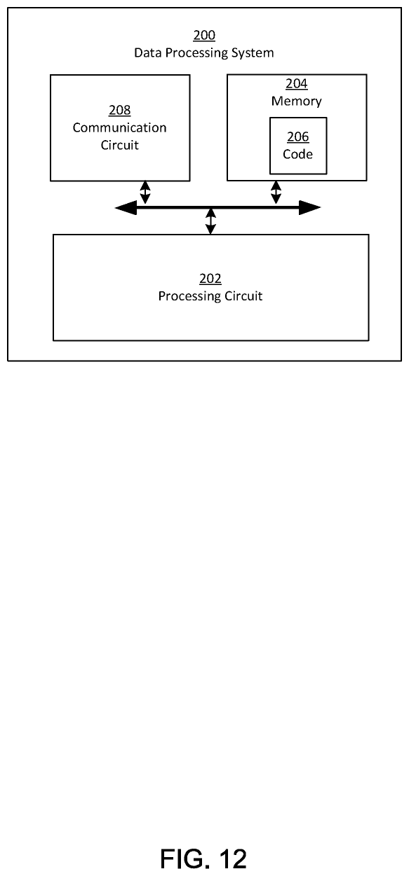

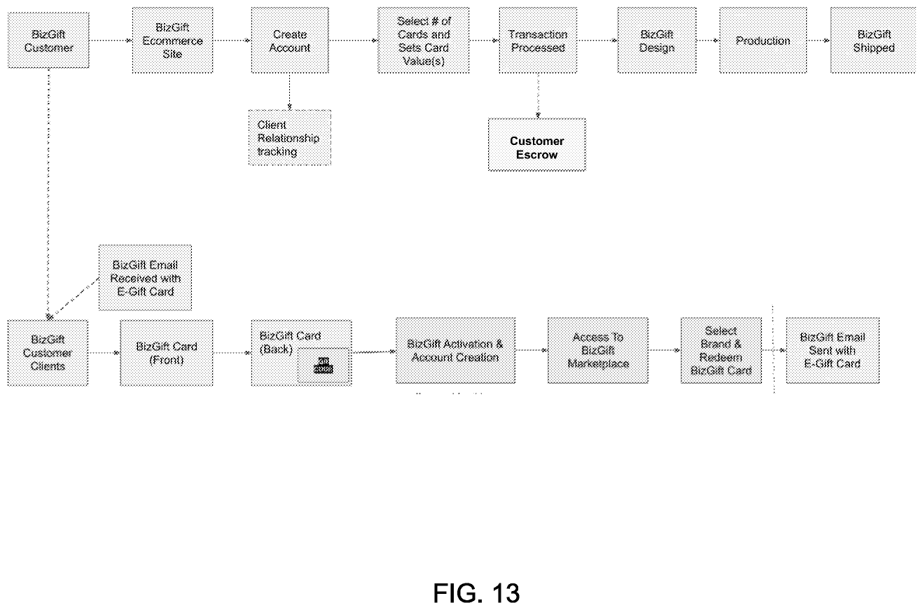

FIG. 12 shows an example data processing system 200 that may be used to implement systems, circuits, components, and/or processes of back end system 14 and front end systems 16, in accordance with one or more arrangements. Data processing system 200 is formed of any suitable size, shape, design, and/or technology and is configured to carry out the one or more of these or related operations/activities described herein. In the arrangement shown, as one example, data processing system 200 includes a processing circuit 202 and memory 204 having software code 206 or instructions that facilitates the processing and/or display of information, and a communication circuit 208, among other components.

Processing circuit 202 may be any computing device that receives and processes information and outputs commands according to software code 206 or instructions stored in memory 204. Memory 204 may be any form of information storage such as flash memory, ram memory, dram memory, a hard drive, or any other form of memory. Processing circuit 202 and memory 204 may be formed of a single combined unit. Alternatively, processing circuit 202 and memory 204 may be formed of separate but electrically connected components. Alternatively, processing circuit 202 and memory 204 may each be formed of multiple separate but electrically connected components.

Software code 206 or instructions is any form of information or rules that direct processing circuit 202 how to receive, interpret, and respond to information to operate as described herein. Software code 206 or instructions is stored in memory 204 and accessible to processing circuit 202. As an illustrative example, in one or more arrangements, software code or instructions may configure processing circuit 202 to interact with users via front end systems 16 and perform various processes in response to user input.

Communication circuit 208 is formed of any suitable size, shape, design, and/or technology and is configured to facilitate communication with back end system 14. In one or more arrangements, as one example, communication circuit 208 includes a transceiver circuit and an antenna. A transceiver is any electronic device that facilitates two-way communication, that is, the delivery of information between data processing system 200 and other components of the system 10. An antenna is any device that is configured to receive wireless signals from over-the-air communication and/or transmit wireless signals in over-the-air communication. In an example arrangement, a transceiver of communication circuit 208 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 208 may be configured to communicate over a wired communication channel.

In various arrangements, communication circuit 208 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of back end system 14, front end system 16, or other portions go system 10 may be primary described or shown as being implemented together on the same system, machine, network, program or process, the arrangements are not so limited. Rather it is contemplated that such components, systems, programs, or processes of back end system 14, front end system 16 or other portions go system 10 may be implemented separately on by separate processes or programs and/or on separate circuits, systems, and/or components on the same bus or network or communicatively connected between different networks. Conversely, although in some arrangements, various circuits, components, systems, programs, or processes of back end system 14, front end system 16, or other portions of system 10 may be primary described or shown as being implemented separately, the arrangements are not so limited. Rather it is contemplated that such components, systems, programs, or processes of back end system 14, front end system 16 or other portions of system 10 may be implemented together on by the same processes or program and/or on the same circuit, system, and/or component on the same bus or network or communicatively connected between different networks.

### Analytics and Machine Learning

In one or more embodiments, back end system 14 or other component of system 10 is configured to perform analytics on data relating to distribution and use of marketing cards 20 and/or interactions with card recipients, for example, to derive insight or additional data metrics that may be useful for future marketing efforts as previously described. In one or more arrangements, such analytics processes and/or other processes or components of system 10 may be configured to monitor, learn, and modify one or more processes, features, functions, and/or operations of the system 10. For instance, in one or more arrangements, analytics processes may be configured to monitor and/or analyze marketing card 22 and recipient data and/or other data sources and learn, over time, data metrics indicative of different milestones, events, conditions or scenarios that may be of interest to or require the attention of a customer.

Such learning may include, for example, generation and refinement of classifiers and/or state machines configured to map input data values to outcomes of interest or to operations to be performed by the system 10. In various embodiments, analysis by analytics processes and/or other processes or components of system 10 may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof. From the above discussion, it will be appreciated that one or more arrangements provide a system and/or method for distribution and management of promotional gifts for marketing and client relations that: improves upon the state of the art, that facilitates distribution and management of promotional gift cards, that facilitates distribution and management of promotional gift cards in a manner that permits recipients to select a desired retailer for the gift card, that facilitates distribution and management of promotional gift cards that is branded as the marketer's company, that that facilitates distribution and management of promotional gift cards that include the marketer's contact information, that facilitates distribution and management of promotional gift cards that does not require the marketer purchase gift cards in advance, that facilitates distribution and management of promotional gift cards that can be distributed in person or though e-marketing campaigns; that collects contact information of recipient for additional marketing, that facilitates distribution and management of promotional gift cards that is easy to use, that is efficient to use, and/or that can be used with a wide variety of industries and marketing campaigns.

It will be appreciated by those skilled in the art that other various modifications could be made to the device without parting from the spirit and scope of this disclosure. All such modifications and changes fall within the scope of the claims and are intended to be covered thereby.

What is claimed:

1. A system, comprising;
a front end system;
a back end system;
wherein the back end system is communicatively connected with the front end system;
wherein the front end system is configured to provide a customer user interface for a customer to access the back end system to facilitate the purchase and management of a plurality of marketing cards by the customer;
wherein the customer user interface is configured to prompt the customer to create a marketing card design with branding and contact information of the customer;
wherein the customer user interface is configured to prompt the customer to select a monetary value to be assigned to each of the plurality of marketing cards;
wherein back end system is configured to generate a unique identifier for each of the plurality of marketing cards;
wherein back end system is configured to encrypt unique IDs/codes to produce a set of secure unique IDs/codes;
wherein the customer user interface is configured to enable the customer to specify a set of email addresses and/or SMS numbers for digital delivery of one or more of the plurality of marketing cards as digital marketing cards;
wherein the back end system is configured to electronically communicate the digital marketing cards to the set of email addresses and/or SMS numbers;
wherein the one or more of the digital marketing cards include respective ones of the set of secure unique IDs/codes;
wherein the front end system configured to provide a recipient user interface for a recipient of one or the plurality of marketing cards from customer to activate a received one of the plurality of marketing cards;
wherein the digital marketing cards include a web link, QR code, or other mechanism to direct recipients to the recipient user interface provided by the front end system;
wherein when a recipient is directed to the recipient user interface, the recipient user interface is configured to receive the secure unique ID/code for the digital marketing card of the recipient;
wherein in response to receiving the secure unique ID/code via the recipient user interface, the system is configured to authenticate the digital marketing card using the secure unique ID/code;
wherein the system is configured to verify the identity of the recipient directed to the recipient user interface by:
generating a challenge message and electronically communicating it to an email address or SMS number associated with the recipient;
prompting the recipient to provide the challenge message as a confirmation message;
determining whether the identify of the recipient is verified based on a comparison, by a processor, of the confirmation message to the challenge message;
wherein the back end system is configured to proceeding with activation of the digital marketing card for the recipient in response to successful authentication of the digital marketing card and verification of the identity of the recipient.

2. The system of claim 1, wherein the web link, QR code, or other mechanism includes a web address for the recipient user interface;
wherein the web address includes the secure unique ID/code as a slug.

3. The system of claim 1, wherein the back end system is configured to encrypt the unique IDs/codes using a plurality of different encryption scripts by, for each of the unique IDs/codes to be encrypted:
randomly selecting one of the plurality of different encryption scripts;
encrypting the unique ID/code using the selected one of the plurality of different encryption scripts; and
concatenating an identifier for the selected one of the plurality of different encryption scripts with the encrypted unique ID/code to form a secure unique ID/code.

4. The system of claim 1, wherein authenticating the digital marketing card using the secure unique ID/code includes:
decrypting an encrypted unique ID/code in the secure unique ID/code to produce a decrypted unique ID/code; and
verifying that the decrypted unique ID/code corresponds to a valid marketing card that has not already been activated.

5. The system of claim 1, wherein the back end system is configured to encrypt the unique IDs/codes using a plurality of different encryption scripts by, for each of the unique IDs/codes to be encrypted:
randomly selecting one of the plurality of different encryption scripts;
encrypting the unique ID/code using the selected one of the plurality of different encryption scripts; and
concatenating an identifier for the selected one of the plurality of different encryption scripts with the encrypted unique ID/code to form a secure unique ID/code;
wherein authenticating the digital marketing card using the secure unique ID includes:
decrypting an encrypted unique ID/code in the secure unique ID/code to produce a decrypted unique ID/code; and
verifying that the decrypted unique ID/code corresponds to a valid marketing card that has not already been activated.

6. The system of claim 1, wherein the customer user interface is configured to prompt the customer to create an account in the back end system;
wherein the customer user interface is configured to prompt the customer to add funds to the account;
where in activating one or the plurality of marketing cards, the recipient user interface is configured to prompt the recipient of one or the plurality of marketing cards to select a retail gift card having the monetary value of the marketing card to be activated;
wherein activation of the marketing card for the selected retail gift card causes the selected retail gift card to be sent to the recipient;
wherein the back end system is configured to deduct the monetary value for the selected retail gift card from the account when the marketing card is activated for the selected retail gift card.

7. The system of claim 1, wherein the customer user interface is configured to enable the customer to request one or more of the plurality of marketing card having the marketing design to be printed and mailed to the customer for distribution as physical marketing cards.

8. The system of claim 1, wherein the back end system includes a sales system;
the sales system configured to facilitate the purchase of the plurality of marketing cards by the customer.

9. The system of claim 1, wherein the customer user interface is configured to permit a customer to configure at least three characteristics of the marketing card from a set of characteristics including: content/information on the marketing card, graphics of the marketing card, layout of the marketing card, shape of the marketing card, and material of the marketing card.

10. The system of claim 1, wherein the plurality of marketing cards include branding and contact information of the customer.

11. A system, comprising;
a front end system;
a back end system;
the back end system communicatively connected with the front end system;
the front end system configured to provide a customer user interface for a customer to access the back end system to facilitate the purchase and management of a plurality of marketing cards by the customer;
wherein the customer user interface is configured to prompt the customer to create a marketing card design with branding and contact information of the customer;
wherein the customer user interface is configured to prompt the customer to select a monetary value to be assigned to each of the plurality of marketing cards;
wherein the plurality of marketing cards each have a unique identifier and/or code;
wherein the customer user interface is configured to prompt the customer to create an account in the back end system;
wherein the customer user interface is configured to prompt the customer to add funds to the account;
the front end system configured to provide a recipient user interface for a recipient of one or the plurality of marketing cards from customer to access the back end system to facilitate the selection of a retail gift card by the recipient and activation of marketing card for the selected retail gift card having the monetary value using the unique identifier and/or code;
wherein activation of the marketing card for the selected retail gift card causes the selected retail gift card to be sent to the recipient;
wherein the back end system is configured to deduct the monetary value for the selected retail gift card from the account when the marketing card is activated for the selected retail gift card.

12. The system of claim 11, wherein the customer user interface is configured to enable the customer to request one or more of the plurality of marketing card having the marketing design to be printed and mailed to the customer for distribution as physical marketing cards.

13. The system of claim 11, wherein the back end system includes a sales system;
the sales system configured to facilitate the purchase of the plurality of marketing cards by the customer.

14. The system of claim 11, wherein the customer user interface is configured to permit a customer to configure at least three characteristics of the marketing card from a set of characteristics including: content/information on the marketing card, graphics of the marketing card, layout of the marketing card, shape of the marketing card, and material of the marketing card.

15. The system of claim 11, wherein the plurality of marketing cards include branding and contact information of the customer.

16. The system of claim 11, wherein the recipient user interface includes branding and contact information of the customer.

17. The system of claim 11, wherein the back end system includes a marketing card management system;
wherein the marketing card management system is configured to track status and balances of the plurality of marketing cards.

18. The system of claim 11, wherein the recipient user interface is configured to prompt the recipient to provide contact information and consent to be contacted by customer for marketing purposes.

19. The system of claim 11, wherein the back end system includes an API configured to provide access to a provider site for purchase of the retail gift card.

20. A method, comprising:
generating a set of unique IDs /codes for a plurality of digital marketing cards;
Encrypting the set of unique IDs/codes to produce a set of secure unique IDs/codes;
electronically communicating one or more of the digital marketing cards having respective ones of the set of secure unique IDs/codes to one or more recipients;
in response to a recipient of the one or more recipients providing a transaction request message having for activation of one of the plurality of digital marketing cards, conducting a secure transaction for activation of a marketing card by:
authenticating the digital marketing card by:
decrypting the secure unique ID /code for the digital marketing card to produce an unencrypted unique ID/code;
comparing, by a processor, the unencrypted unique ID/code with store information relating to the set of unique ID/code to confirm the unencrypted unique ID/code is valid and has not yet been activated;
verifying the identity of the recipient by:
generating a challenge message and electronically communicating it to an email address or SMS number associated with the recipient;
prompting the recipient to provide the received challenge message as a confirmation message;
determining whether the identify of the recipient is verified based on a comparison, by a processor, of the confirmation message to the challenge message;
proceeding with activation of the digital marketing card for the recipient in response to successful authentication of the digital marketing card and verification of the identity of the recipient.
